(19) United States
(12) Patent Application Publication
(10) Pub. No.: US 2009/0296600 A1
(43) Pub. Date: Dec. 3, 2009

(54) Method and Device for Analysis and Visualization of a Network

(76) Inventors: Geoffrey Canright, Oslo (NO); Kenth Engø-Monsen, Fredrikstad (NO); Åsmund Weltzien, Oslo (NO)

Correspondence Address: MCDERMOTT WILL & EMERY LLP, 600 13TH STREET, N.W., WASHINGTON, DC, 20005-3096, US

(21) Appl. No.: 12/084,232

(22) PCT Filed: Oct. 27, 2006
(86) PCT No.: PCT/NO2006/000379

§ 371 Date: Apr. 3, 2009

(30) Foreign Application Priority Data
Oct. 28, 2005 (NO) 20055034

(51) Int. Cl. H04L 12/26

(52) U.S. Cl. 370/254

(57) ABSTRACT

A method for analysis and visualization of a network is disclosed. The analysis method is based on the use of the steepest ascent graph (SAG). Specifically, the method: (i) uses the SAG to define subregions, in a way that allows iterative refinement; (ii) presents a new and highly efficient way of calculating the SAG; (iii) uses the SAG, and the definitions in (i), as the foundation of a novel method for displaying the structure of the network in a two-dimensional visualization.

### FIELD OF THE INVENTION

The present invention addresses the problem of understanding and controlling the flow of information in networks, with the aim of spreading or preventing spreading of information in said networks. The invention involves analyzing the structure of a given network, based on the measured topology (the nodes of the network and the links between them). The networks in question may be any kinds of networks, but the invention is particularly applicable in communication networks.

### TECHNICAL BACKGROUND

There exist many methods for defining well connected clusters in a network; but only the regions-analysis method disclosed in the applicant's earlier Norwegian patent applications NO 20035852 and NO 20053330 has been shown to have direct utility for understanding and controlling spreading of information on the network. Specifically, in NO 20035852 we have presented a basic method for analyzing networks. This method is valid whenever the links of the network may be viewed as symmetric—i.e., whenever flow of information over a link may (at least approximately) be assumed to be equally likely in either direction on the link. A principal output of this method is the assignment of each node to a region (well connected cluster) of the network. The analysis predicts that information spreading will be relatively faster within regions than between them. Hence knowledge of these regions is useful for controlling the spread of information—that is, either hindering the spread of harmful information (such as computer viruses) or aiding the spread of useful information. Geoffrey Canright and Kenth Engφ-Monsen, “Roles in Networks”. Science of Computer Programming, 53 (2004) 195-214, is a research article which describes the analysis method in detail.

Geoffrey Canright and Kenth Engφ-Monsen. “Spreading on networks: a topographic view” to appear in Proceedings, European Conference on Complex Systems, 2005 (ECCS05) and Geoffrey S. Canright and Kenth Engφ-Monsen, “Epidemic spreading over networks: a view from neighbourhoods”, Telektronikk 101, 65-85 (2005) are further research articles which demonstrate that our definition of regions is indeed extremely useful for understanding how information is spread over a network. Also, in the last paper mentioned, we present methods for modifying the structure of a given network, towards the goal of either helping or hindering information flow. Results of some limited tests of these design methods are presented, which are also described in the Norwegian patent application NO 20053330. The test results reported in the last paper indicate that design and modification techniques that are based on our regions analysis can significantly affect the rate of information spreading.

One shortcoming of our region analysis method is that there has not so far been found any useful way to refine the analysis, i.e., to define subregions within each region. That is, the method allows one to sort the nodes of the networks into a number of regions, defined by their being well connected internally. However, the number of such regions is determined by the analysis, and hence is not subject to any choice by the user of the analysis. Also, for a sufficiently well connected network, the method can give the answer that the network is composed of a single region. Thus, if a user of this approach wishes to examine smaller subregions than those given by the analysis, new methods are needed. In many cases, it is desirable to be able to iteratively refine the analysis, defining sub-subregions, etc.

M. Girvan and M. Newman, “Community structure in social and biological networks”, Proc. Natl. Acad. Sci. USA, 99 (2002), pp. 8271-8276 describes a method for network analysis which also breaks down a given network into well connected clusters. The Girvan-Newman method has the advantage that the breakdown may be refined as many times as wished, giving subregions, sub-subregions, etc. However, the Girvan-Newman method has no demonstrated connection to the important practical problem of understanding the spreading of information.

Another shortcoming of the region analysis method as described in NO 20035852 is that it can be too demanding in terms of computing power when handling large graphs. An important technical aspect of the regions-analysis method is the calculation of the steepest-ascent graph (SAG) for a given network. This graph is used to assign nodes uniquely to regions. We have discovered, in working with multi-million-node graphs, that it is important to be able to calculate this SAG in an efficient manner. Specifically, we found that an ordinary approach to calculating the SAG in such cases might take several hundred years to complete—thus rendering the whole approach practically impossible.

Finally, we note that a highly desirable feature of any method of network analysis is the possibility for visualizing the resulting structure (as given by the analysis). There has been, and continues to be, a huge volume of work on the problem of visualizing networks. However, the problem of finding a good visualization which presents our ‘regional’ view of a network is largely unsolved.

An overview of current techniques for visualization og graphs may be found in Giuseppe Di Battista, Peter Eades, Roberto Tamassia, and Ioannis G. Tollis, Graph Drawing: Algorithms for the Visualization of Graphs, Prentice Hall PTR, Upper Saddle River, N.J., USA (1998).

### SUMMARY OF THE INVENTION

Thus, a principal objective of the present invention is to provide a method and device for network analysis that solves the shortcomings of prior art methods as mentioned above. The analysis method of the present invention is based on the use of the steepest ascent graph (SAG).

The method according to the present invention for analysis and visualization of a network, said network including a number of nodes inter-connected by links, is as defined in the appended claim 1. Specifically, the method includes at least the steps of mapping the topology of the network, calculating an Adjacency matrix A of said network, from said Adjacency matrix A extracting a neighbour list for each node in the network, calculating an Eigenvector Centrality (EVC) score for each node, from said neighbour list and EVC score identifying the neighbour of the node with the highest EVC score, and creating a matrix Ã with entries for each link in the network, in which the entry for a given link is set to 1 if it is a link between a node and its neighbour with the highest EVC score, said matrix Ã being the Steepest Ascent Graph (SAG) of the network.

The invention also includes a device, a computer program product and a computer readable medium as claimed in the appended claims.

### BRIEF DESCRIPTION OF THE DRAWINGS

The invention will now be given a detailed description, in reference to the appended drawings, in which:

FIG. 1 shows a simple test graph with 16 nodes,

FIG. 2 shows the same graph with contour lines removed,

FIG. 3 shows the subregions of the test graph in FIG. 1,

FIG. 4 shows the sub-subregions obtained by further refinement of the largest subregion in FIG. 3,

FIG. 5 is a schematic tree visualization of the test graph in FIG. 1,

FIG. 6 is a visualization of the Gnutella network using prior art technique,

FIG. 7 shows the steepest-ascent graph of the same network,

FIG. 8 is another prior art visualization of the Gnutella network, taken at another point in time,

FIG. 9 is the corresponding visualization using the steepest-ascent approach,

FIG. 10 shows the graph in FIG. 8, but with the nodes colored according to their region membership,

FIG. 11 is the subregion visualization for the two-region graph of FIG. 9,

FIG. 12 is the same graph with a threshold set for subregion size, i.e. small subregions are not shown,

FIG. 13 shows the subregion visualization for the one-region graph of FIG. 7, also with a threshold set on subregion size.

### DETAILED DESCRIPTION

### Defining Subregions and Refining

We invoke our topographic picture in order to describe the ideas behind this invention. In this picture, each region is a ‘mountain’, and the eigenvector centrality (EVC) index of each node is its ‘height’. For each region, the top of the mountain is called its Center—this is the highest node in the region. We then note that the steepest-ascent graph gives a picture of the ‘ridge’ structure of the mountain. That is, each link which is retained in the steepest-ascent graph is a link from a node to that node's highest (in EVC) neighbor. These links thus represent the likeliest path for information flow towards or from the Center of the region. Furthermore, there is one such ‘ridge line’ (including lower branches) for each neighbor of the Center.

Hence we define a subregion as simply that branch of the SAG (which is a tree) which ends at one neighbor of the Center. That is, each neighbor of the Center sits at the head of a subtree of the SAG tree; and we identify each subtree as a subregion. This definition is not arbitrary, since each subtree represents in fact the set of likeliest paths for information flow between the nodes in the subtree and the Center.

This definition also has the obvious advantage that it allows for iterative refinement. Since a subregion is simply a subtree of the SAG, one can readily define sub-subregions as sub-subtrees. That is, one simply moves ‘down’ the subtree from its head, until the first branching of the subtree. Each branch of the subtree then is defined as a distinct sub-subregion. The extension to even further refinements should be clear from this definition.

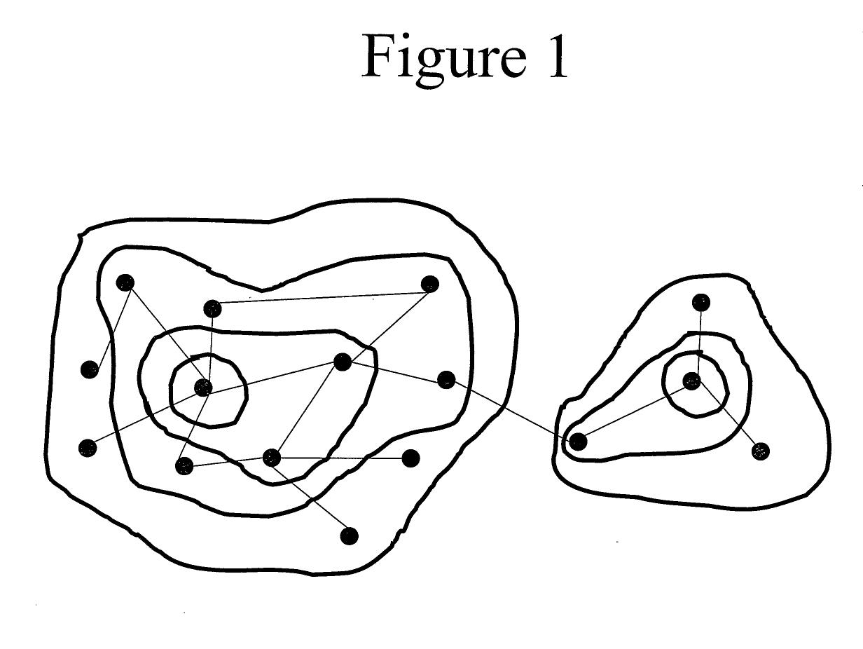

We illustrate the definition of subregions with an example. FIG. 1 shows a simple graph with 16 nodes. ‘Contour lines’ of constant ‘height’ are also shown. It is clear from the figure that a regions analysis gives two regions—one with 12 nodes on the left, and one with 4 nodes on the right. For each region, the Center node is marked with blue color.

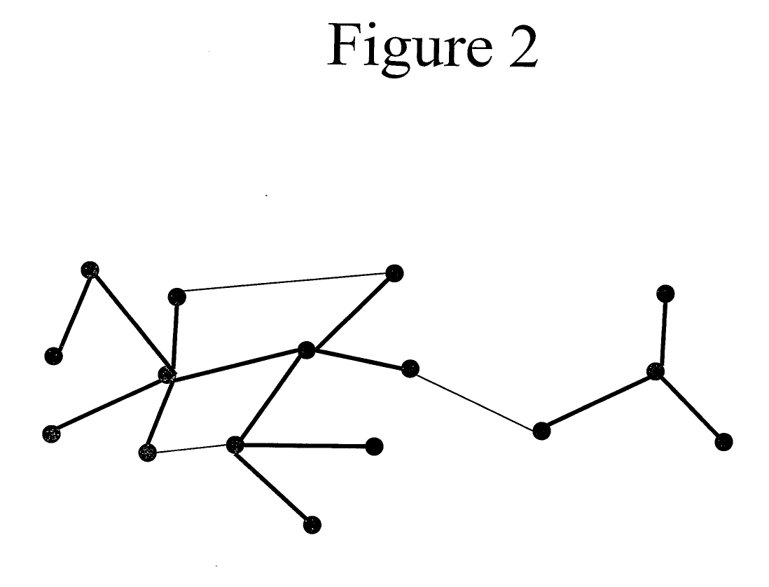

FIG. 2 shows the same graph, with contour lines removed, and with those links lying on the SAG marked with thick lines. Hence the SAG is clearly visible in FIG. 2.

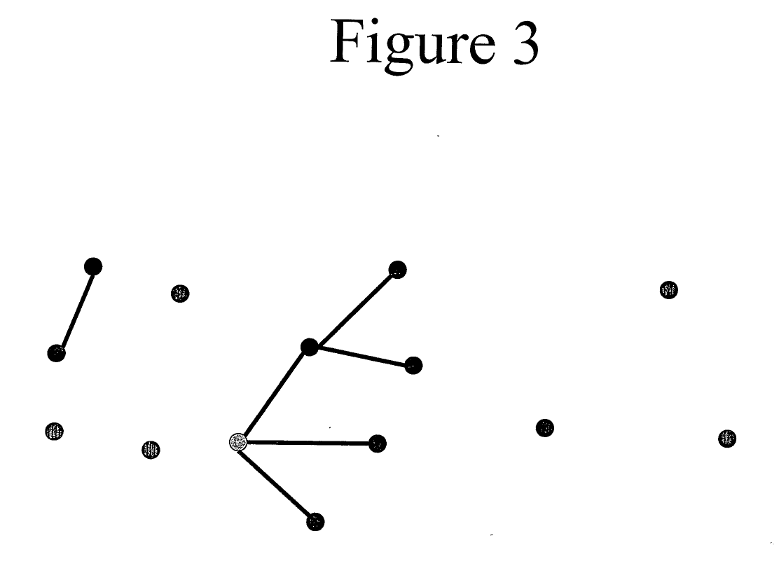

Now we define the subregions for each region. For each region, we remove the Centers, and all links connected to them. Those nodes that were neighbors of a Center are now ‘heads’ of their subregion. These nodes are colored black (see FIG. 3). Nodes which are at the ‘leaves’ of the tree, ie at the end of a chain of links, are still red. Nodes which are both head and leaf (because they represent a one-node subregion) are black/red. Finally, there is a green node which is neither head nor leaf.

Each connected subgraph in FIG. 3 is a subregion of the graph of FIG. 2. Thus we find that there is one subregion with six nodes, one with two nodes, and six subregions with only one node. We note that trials with empirically measured (peer-to-peer) networks have indicated that one can find typically a wide variation in the size of the subregions, and that, even with large empirical networks, one-node subregions are not unusual. Hence FIG. 3 is typical (except for the small size of the whole graph) of the real networks we have examined so far (these having about 1000 nodes).

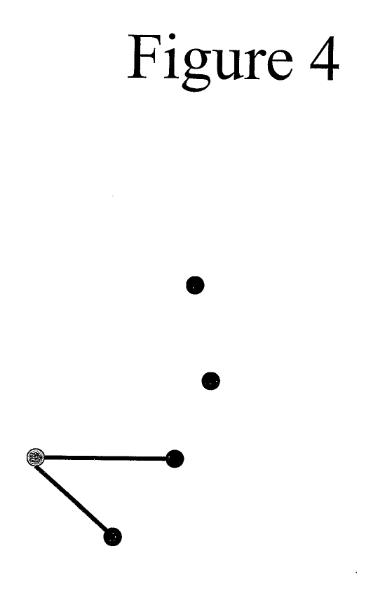

The graph of FIG. 1 allows for one further step of refinement. We illustrate this in FIG. 4, in which we refine the largest subregion of the graph. Refinement consists of removing the head of the subregion, and its links. (If the head has only one neighbor below it, we remove that one also—and so on, until the removed head has multiple neighbors.) There are now three sub-subregions—that is, one for each neighbor of the removed head. The green node is now seen as head of its sub-subregion. The process of refinement is almost completely analogous to the process of defining subregions; also, any further refinements (on larger graphs than that in these Figures) are precisely like the refinement process illustrated here.

Efficient Calculation of the Steepest-Ascent Graph

As noted earlier, we found that applying a straightforward algorithm for finding the SAG gave a projected running time of about 200 years for a test graph with 10 million nodes. The problem here was that the entire test graph did not fit in the fast (RAM) memory of a machine with 4 GB of RAM. Hence we had to resort to ‘external-memory’ algorithms, i.e. approaches which only read in a part of the problem at a time, operate on that part, delete it, and then read in the next part. (For a reference on external memory algorithms, see: External Memory Algorithms, pub. American Mathematical Society, Jan. 1, 1999.) Running time is then strongly constrained by the number of read operations for external memory—these operations are many times (orders of magnitude) slower than access times for RAM.

The present invention solves this problem by giving an algorithm which is optimal in terms of the number of accesses to external memory. That is, our new algorithm reads the neighbor list of each node (which is a column of the adjacency matrix) exactly once. Doing so reduced the running time for our 10-million-node example from (expected) 200 years to 58 hours.

The method builds on the insight that steepest ascent from any given node is actually determined by (a) its highest neighbor, plus (b) steepest ascent from this neighbor. In other words, for each node, we need only find—once and for all—its single highest neighbor (if there is one—otherwise it is a Center, i.e. a local maximum). Thus, for each node, we find and store that one piece of information, and forget all other links.

In short, the SAG requires finding and storing exactly one link for each node. This link is found after a single access to the node's neighbor list, and stored in a separate data structure for the SAG.

In detail, calculation of the SAG begins with several input structures. First of all, we need the adjacency matrix A expressing the topology of the graph (Aᵢⱼ=1 if there is a link between nodes i and j, and 0 otherwise). The 1's in the i'th column (or row) of A thus give the node numbers of those nodes which are neighbors of node i; it is in this sense that we say that we can extract the neighbor list of a node from a column of A.

We also need a vector e giving the eigenvector centrality (EVC) score eᵢ for each node i. We then use the neighbor list of a given node g, and the EVC scores of these neighbors (taken from the vector e), in order to find the single neighbor h of g that has the highest EVC score. We store this result in a new matrix Ã, by placing a 1 at the entry Ã_{gh}. The matrix Ã is in fact the steepest-ascent graph (SAG). It is highly sparse, since it has only one link for each node. Hence it is much more feasible to store all of Ã in RAM than it is to store all of A (which is typically, in terms of storage requirements, 10-20 times as large as Ã). Of course, one need store only the 1's for any sparse, binary matrix, such as A or Ã; but still the former has many more 1's than the latter.

The efficiency of this method, in terms of number of read access events for columns of A, is clear. A naïve approach would pick a node g, and then find its highest neighbor h, then find h's highest neighbor, and so on, until a Center is reached. This naïve approach gives immediate region membership information for each chosen node g; but it clearly requires many more read access events in the case that A is externally stored.

Our method, instead, defers determination of region membership until the entire SAG is stored in Ã. One then determines region membership as follows. One builds a start vector s, such that sᵢ=i. That is, one simply places the node number at that node's entry. Multiplication of s by Ã sends each node number ‘downhill’ in the SAG tree—for example, in the above notation, multiplication by Ã will send the number at h to g (and to all other nodes having h as their highest neighbour). Repeated multiplication by Ã results in a stable vector s*, where the entry in s* for each node g gives the node number of the Center whose region g belongs to. (In the exceedingly rare case that a node belongs to two regions, it will receive the sum of the node numbers for the two Centers—a case that is easily detected.) We note that only a few multiplications by Ã are needed, as the s vector converges exactly to s* after a number of multiplications equal to the radius of the largest region (measured in number of hops). Typical graphs, even very large graphs, have small radii due to ‘small worlds’ effects.

A modified version of the procedure detailed in the previous paragraph can be used in the calculation of subregions. First the SAG must be updated in two ways: i)

Remove the centre node from the tree, causing the SAG to decompose into a number of separate trees, and ii) add self-referencing links to the new root node for each new tree. Subregion membership is then determined by the same procedure given above, applied to each separate tree.

Visualization

We describe two methods for visualising the structure of a network, based on the analysis method presented here. We call these two methods ‘Tree visualization’ and ‘Subregion visualization’ respectively.

Tree Visualization

For Tree visualization we proceed as follows:
1. First consider each region as an isolated subgraph, ie, ignore inter-region (‘bridge’) links.
2. Find the SAG for each region separately.
3. Use freely available force-balance packages to display the resulting tree structures on the screen. For multiple regions, one can display multiple trees.
4. One can also calculate a ‘net link strength’ between any given pair of subregions-either from the same region, or from distinct regions. One can then use this net link strength to determine which subregions (subtrees) should lie closest to one another in the tree (SAG) representing one region.

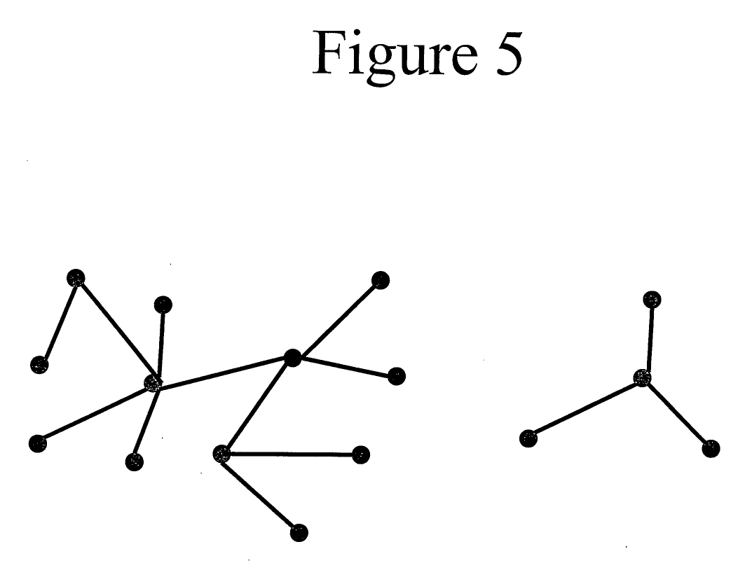

FIG. 5 shows the tree visualization for the graph of FIG. 1. This figure is only schematic—that is, we have not used any force balance package to lay out the nodes.

A practical approach to tree visualization is outlined above. Our approach uses freely available software to actually lay out the nodes in the plane; the new idea simply comes from discarding all links other than those in the SAG. In other words, tree visualization involves building the SAG (as outline above), and then simply feeding the SAG as a graph to a force-balance visualization program such as UCINet (UCINet and NetDraw may be downloaded from: http://www.analytictech.com/).

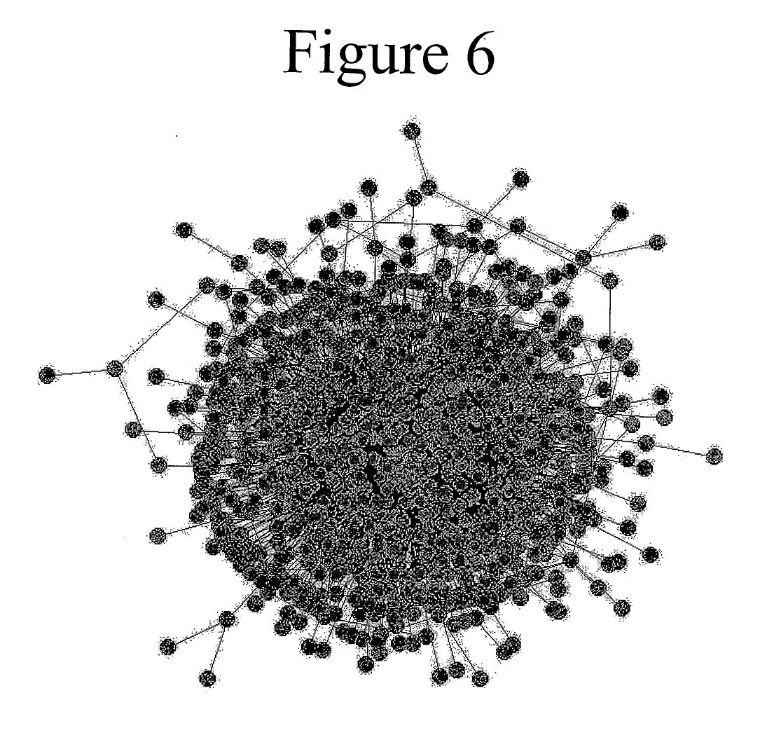

We offer more realistic examples of tree visualization in FIGS. 6-10. FIG. 6 shows a snapshot of the Gnutella peer-to-peer file-sharing network, taken in 2001. It has about 1000 nodes. The visualization in FIG. 6 was performed using NetDraw, a component of the network analysis package UCINet. This is thus a state-of-the-art visualization; but it reveals (as is common with large networks) a structureless mess.

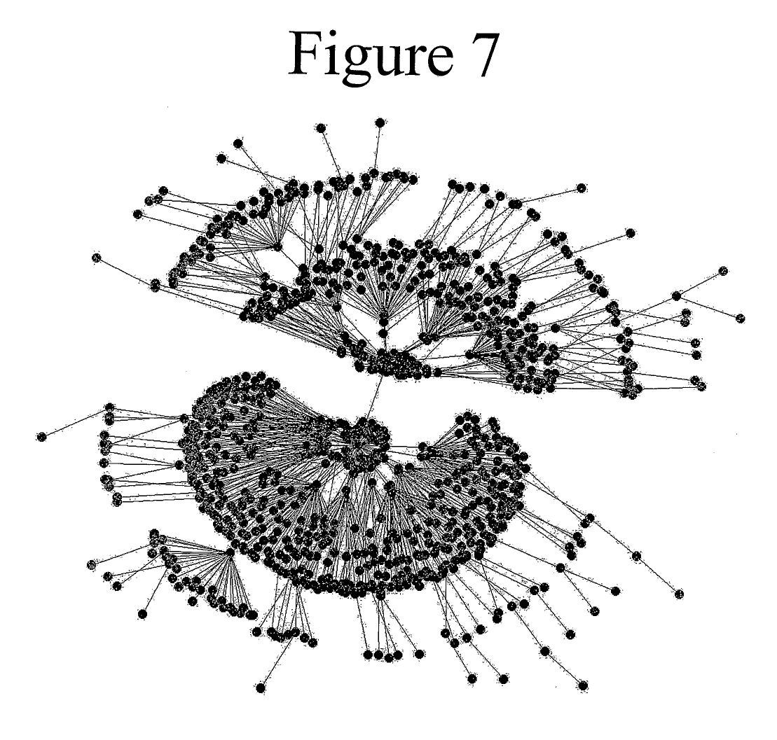

FIG. 7 shows the same graph, laid out again by NetDraw; but the input to NetDraw was the steepest-ascent graph as found by our analysis. We see that our analysis finds only one region; but FIG. 7 reveals a rich internal subregion structure for this one region. In fact, many layers of substructure are already visible in FIG. 7; and it is clear that refinement of the subregions will only bring out this substructure even more clearly.

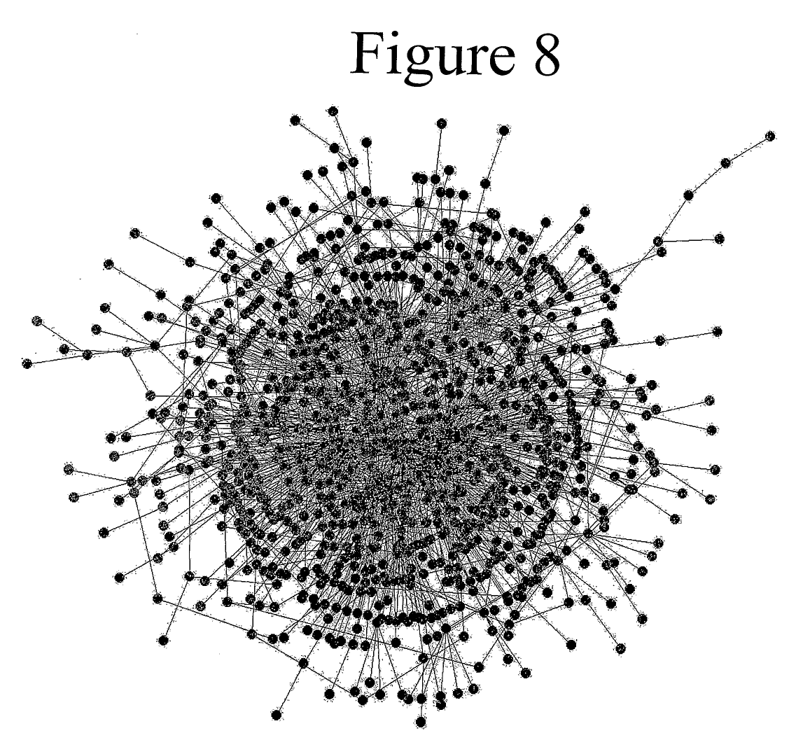

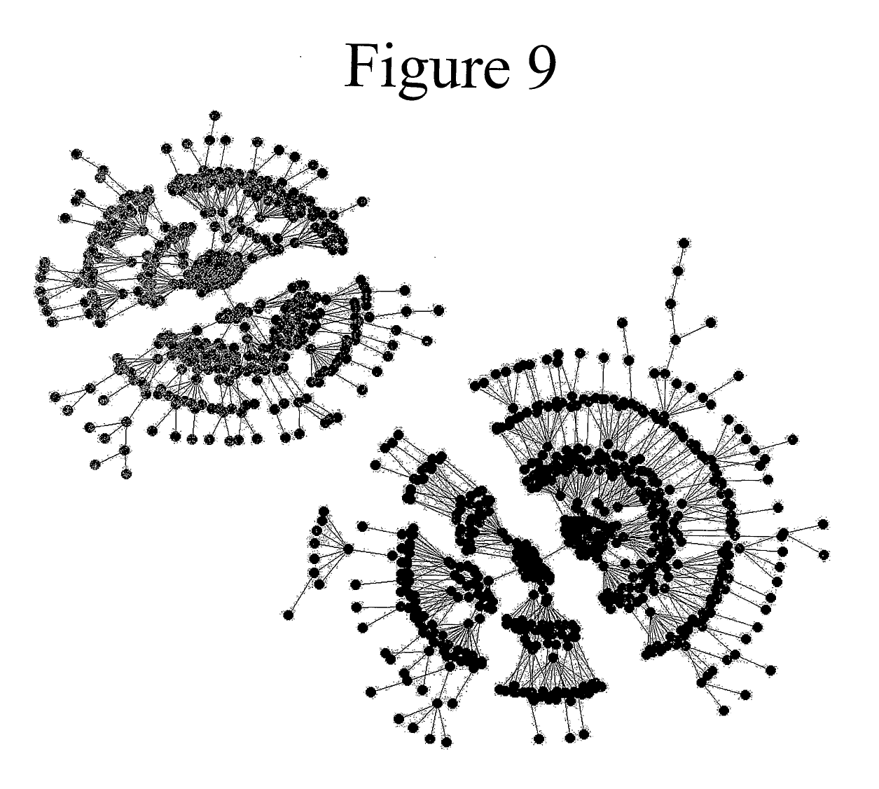

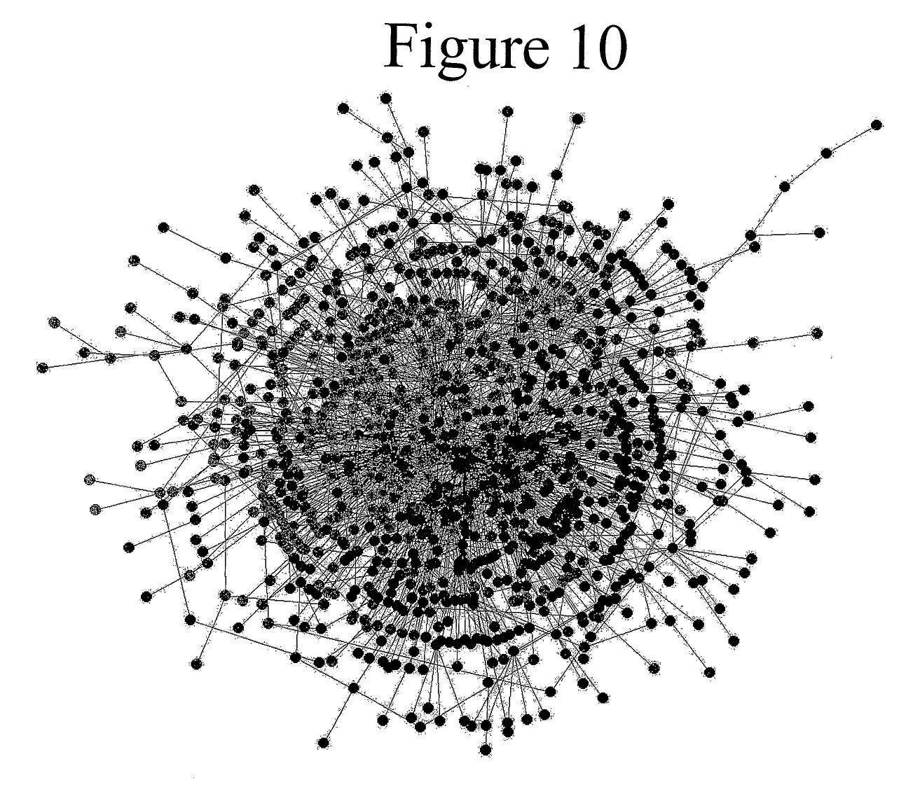

FIG. 8 shows a different Gnutella snapshot, again with about 1000 nodes, again drawn using the full link structure and NetDraw. FIG. 9 shows that our analysis finds two regions for this snapshot. Again the contrast (compare FIGS. 8 and 9) is striking. FIG. 10 is the same layout as in FIG. 8, but with the nodes colored according to their region membership (as found by our analysis). The point of FIG. 10 is that the two-region structure is partially visible in the layout using the full link structure (assuming one knows how to assign the nodes to regions). Hence FIG. 10 gives some indication of the network's structure—more than does FIG. 8—but FIG. 9 shows both the two-region main structure, and many levels of substructure, much more clearly.

There are many subregions for the single region in FIG. 7, and for each of the two regions in FIG. 9. Clearly, for a tree structure, all subregions should radiate outwards from the center; but there is no obviously best criterion for determining which subregions are ‘neighbors’ as they are laid out in a ring around the Center. The layouts shown in these two figures used the simple, standard mechanism of force-balance algorithms that every node has a degree of repulsion with respect to every other. Thus the force balance itself was allowed to determine the radial ordering of the subregions. We see that the results of using this simple default method are good.

It is also possible to use more information to guide the radial ordering of the subtrees. One can define and calculate a measure of ‘net link strength’ (as described in more detail below) between any given pair of subregions, and then use this net link strength to guide in the placement of the subtrees. For example, one can place a fictitious extra link between the respective heads of each pair of subtrees, giving a weight to this link that is determined by the net link strength between the subtrees (subregions). The force balance method will then tend to drive subtrees towards one another if they have a high net link strength between them.

We note that the use of net link strength may have an advantage with very large graphs. That is, for very large graphs, even the SAG tree structure may be too time consuming to lay out with force balancing. In such a case, using extra inter-head links, with a high link weight compared to the SAG links, is likely to speed up convergence-perhaps considerably.

Methods for calculating net link strength will be given in the next subsection, since this quantity plays a crucial role in subregion visualization.

Finally, we emphasize that tree visualization is readily suited for displaying refinements of the subregions. Refinement of a given subregion picture simply gives a new set of subtrees, which may then be handled precisely as for the case of multiple trees from multiple regions. FIG. 4 is (again) a schematic example of one step of refinement, starting from the tree visualization of FIG. 3.

Subregion Visualization

The procedure for Subregion visualization is as follows:
1. First consider each region as an isolated subgraph, i.e., ignore inter-region (‘bridge’) links.
2. Find the SAG for each region separately.
3. For each subregion, determine its size (number of nodes).
4. Choose a threshold size T. Subregions of size smaller than T are not displayed, to save clutter. All subsequent steps apply only to subregions of size ≧T.
5. For each SAG, calculate the net link strength between each pair of subregions.
6. Remove the Center of each region, so that the subregions are decoupled from one another at the Center. Their only remaining coupling is then the pairwise couplings formed by the net inter-subregion link strength; and the resulting structure is no longer a tree.
7. For each region, build a ‘coarse-grained graph’ by representing each subregion as a single node, and using the inter-subregion net link strengths as the links. Display the resulting coarse-grained graphs for each region, using a freely available force-balance package. The displayed size of the nodes in the coarse-grained graphs may be used to indicate the size (number of actual nodes) for the corresponding subregion; and the net link strengths may be displayed using the thickness of the displayed links in the coarse-grained graph.

Subregion visualization requires a few more steps to explain than does tree visualization. For this reason, we repeat the steps given above, adding further details where appropriate.
1. First consider each region as an isolated subgraph, ie, ignore inter-region (‘bridge’) links.
2. Find the SAG for each region separately.
3. For each subregion, determine its size (number of nodes).

These three steps are clear.
4. Choose a threshold size T. Subregions of size smaller than T are not displayed, to save clutter. All subsequent steps apply only to subregions of size ≧T.

It is always useful in visualization to be able to choose a level of resolution, i.e., the level of detail that one wishes to have displayed. Subregion visualization already removes much detail by simply displaying each subregion as a single node. However there can be very large variation in the size of the subregions. For example, the graph of FIG. 7 yields subregions of size ranging from 1 to about 350—with a large number of tiny subregions, and only a few large ones. Furthermore, we expect this kind of distribution to be typical of many real networks. Hence it can be desirable to suppress the display of the many tiny subregions, and focus on the large ones.
5. For each SAG, calculate the net link strength between each pair of subregions.

In principle, there are many ways to define this net link strength. We give here a formula, based on two ideas: (i) links with high EVC get more weight; (ii) many links give more weight than few links.

To implement these two ideas, we define the ‘arithmetic link centrality’ for a link between nodes i and j to be the arithmetic average of the two nodes' EVC scores:

$${a}_{ij} = \frac{( {e}_{i} + {e}_{j} )}{2} . \qquad ( 1 )$$

Alternatively, one can define the ‘geometric link centrality’ gᵢⱼ for a link between nodes i and j to be the geometric average of the two nodes' EVC scores:

gᵢⱼ={square root over ((eᵢ*eⱼ)}.

We then define the net link strength between two subregions α and β to be the sum of the link centralities for all links connecting α and β. This gives

$$NLS ( α , β ) = {\sum }_{i ∈ α} {\sum }_{j ∈ β} {a}_{ij} . \qquad ( 2 )$$

We note finally that one can violate the instruction in step 1, for graphs with multiple regions. That is, an even more thorough overview may be obtained by calculating, and including the effects of, all inter-subregion net link strengths—both those between subregions in the same region, and those between subregions in different regions. [Formula (2) is equally valid for a pair of subregions taken from two distinct regions.] This will allow the resulting display to take into account inter-regional relations, so that the final layout reflects most clearly the whole set of relationships. Our default choice is however to treat each region separately.
6. Remove the Center of each region, so that the subregions are decoupled from one another at the Center. Their only remaining coupling is then the pairwise couplings formed by the net inter-subregion link strength; and the resulting structure is no longer a tree.

Here we see that the subregions are now treated as individual nodes (as far as visualization is concerned). They have a ‘size’ (from step 3), and they have internode links with link strengths given as detailed in step 5. The Center is removed as it does not belong to any subregion; and the aim of subregion visualization is to try to display the subregions (only) and their relationship to one another.

Thus we end up with a visualization problem with S nodes (for S subregions of size ≧T), and, in general, links of some strength between most pairs of nodes. Thus our coarse-grained graph is in fact a dense graph—it is not sparse, since most of the possible links are present. However, two aspects make this visualization problem much easier than the problem of visualizing the entire network. First, the number S of subregions for a given region is guaranteed to be very much smaller than the number N of nodes in the graph—it is not more than the number of neighbors for the Center of the region (a number much less than N already), and is likely to be much smaller than even that number, if the threshold size T is set to exclude many small subregions. Secondly, there is likely to be large differences in the various net link strengths in the resulting dense graph. These differences make convergence in the force-balance method much easier than it would be if all links had the same, or nearly the same, strength.
7. For each region, build a ‘coarse-grained graph’ by representing each subregion as a single node and using the inter-subregion net link strengths as the links. Display the resulting coarse-grained graphs for each region, using a freely available force-balance package. The node size in the coarse-grained graphs may be used to indicate the number of nodes for the corresponding subregion; and the net link strengths may be displayed using the thickness of the displayed links in the coarse-grained graph.

All of the techniques needed for this step are publicly available. There are of course other ways (eg, colors) to indicate scalar measures of node size and link strength. We do not exclude any such method here. The essential information that we want to include in this invention is that both the node (subregion) size, and the net (inter-subregion) link strength, can and should be displayed in subregion visualization; they are an important part of the total picture of how the subregions are related to one another.

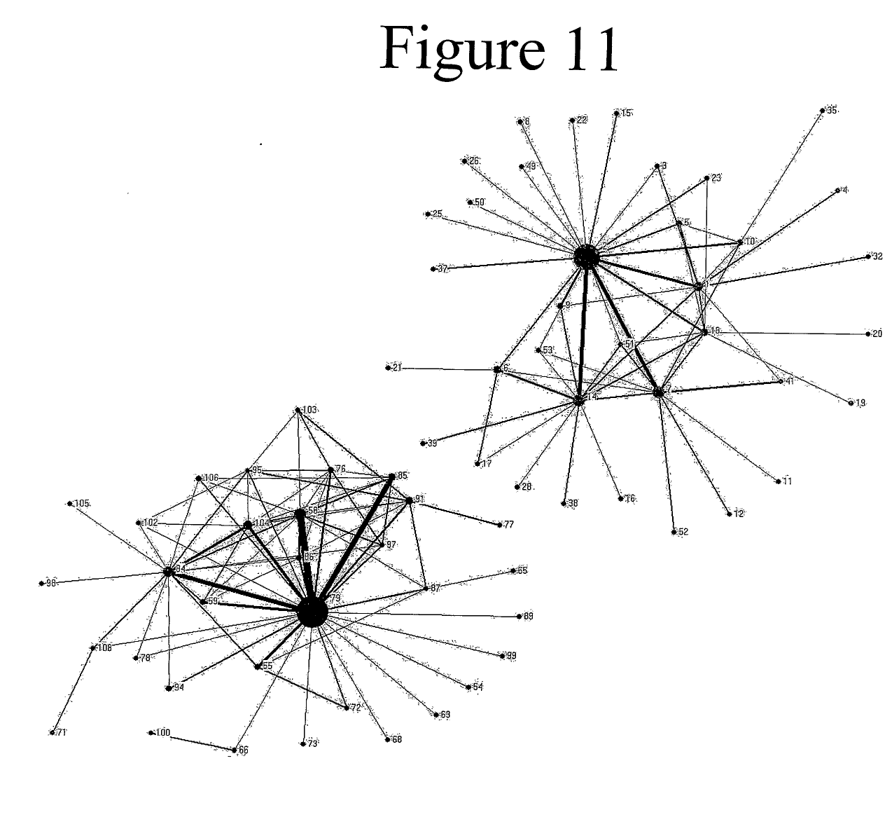

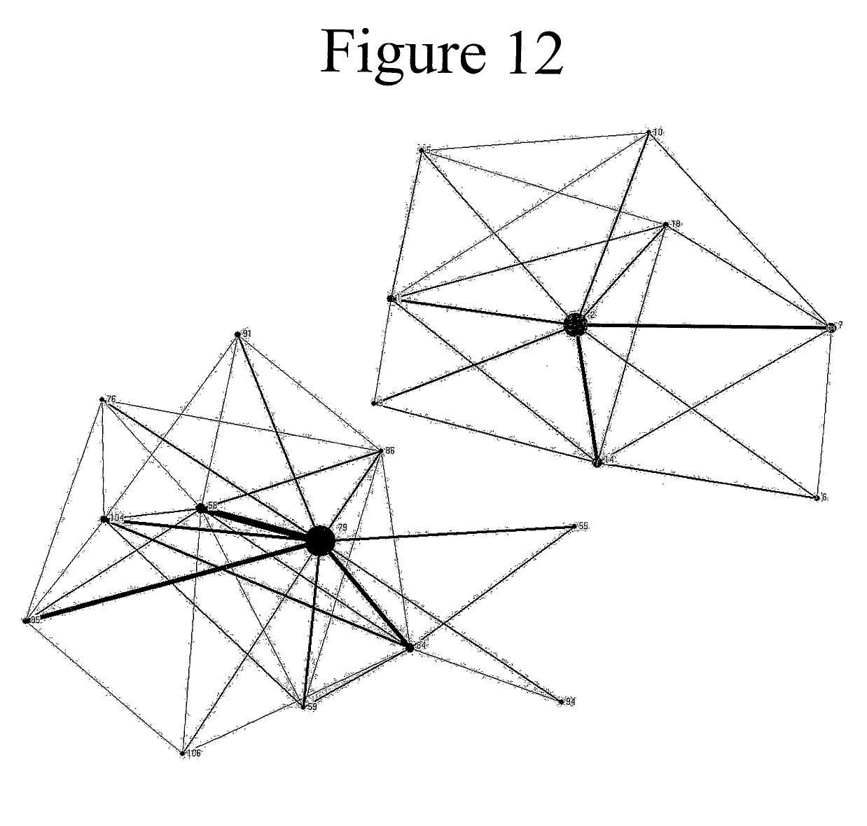

FIG. 11 shows the subregion visualization for the two-region graph of FIG. 9, with threshold T=1—that is, all subregions are shown. For comparison, in FIG. 12 we have set T=10. The reduction in clutter is significant. We note that it is not trivially easy to find correspondences between subregion structures in FIG. 9 and those in FIG. 11 or 12. We believe that this is because each type of visualization emphasizes different, but useful, structural information about the network under study. That is, the two methods are complementary, rather than redundant.

Some main features can however be found to correspond. For example, the largest ‘red’ subregion in FIG. 11 corresponds to the entire ‘lower half’ of the red region in FIG. 9; we know that the lower half is a subregion, because the Center of that region is at the hub of the upper half. The same kind of correspondence may be found for the blue region.

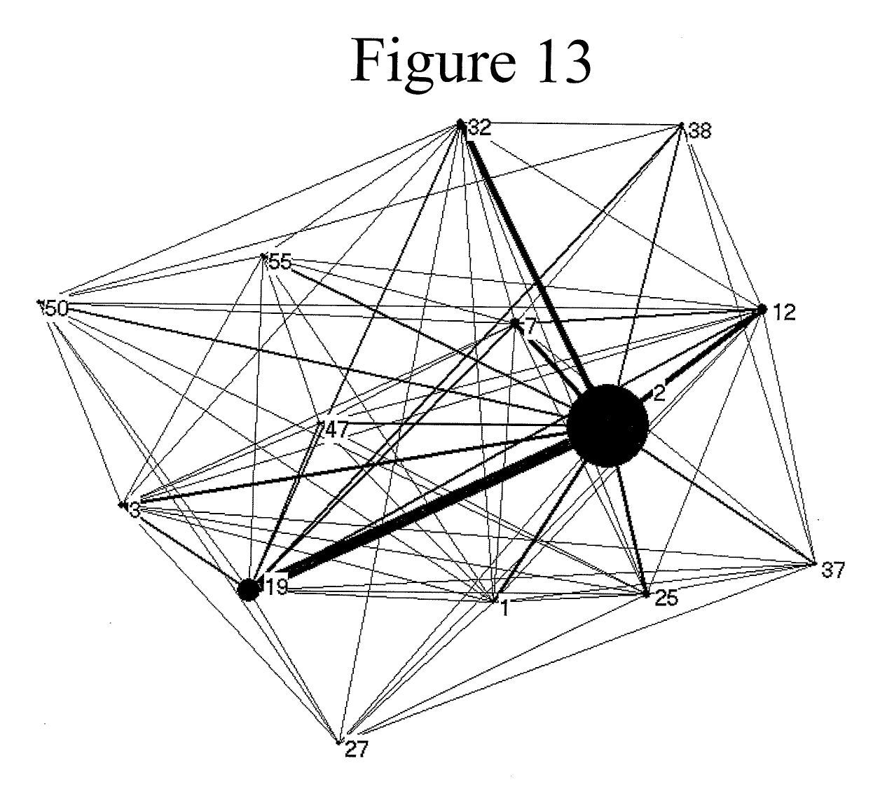

For completeness, we show in FIG. 13 the subregion visualization for the one-region graph of FIG. 7, with T=10. Here again we see one very large subregion, corresponding to the ‘upper half’ of FIG. 7.

There are many conceivable applications of the inventive method. We list several here:
Analysis and improvement of information flow in organizations
Systems for supporting other kinds of social networks, e.g. online communities
Security for computer networks, e.g. virus control
Novel strategies for controlling the spreading of diseases among animals and humans
Limiting the spread of damage in technological networks, for example power networks

The method may be performed in a device including a controller and a storage device. The controller may be realized as a server, and the storage device may be a database controlled by the server. The storage device/database is storing setup information regarding each node in a network. The setup information includes information on the connections/interfaces to/from each node. The device may also be interfaced to the network, and be adapted to retrieve this information from the nodes. In other cases this information must be gathered in other ways, e.g. when the nodes in question not are communication nodes. For communication nodes, traffic information may be gathered from each node, such as traffic counts.

The method according to the present invention may be implemented as software, hardware, or a combination thereof. A computer program product implementing the method or a part thereof comprises a software or a computer program run on a general purpose or specially adapted computer, processor or microprocessor. The software includes computer program code elements or software code portions that make the computer perform the method using at least one of the steps according to the inventive method.

The program may be stored in whole or part, on, or in, one or more suitable computer readable media or data storage means such as a magnetic disk, CD-ROM or DVD disk, hard disk, magneto-optical memory storage means, in RAM or volatile memory, in ROM or flash memory, as firmware, or on a data server.

It will be understood by those skilled in the art that various modifications and changes may be made to the present invention without departure from the scope thereof, which is defined by the appended claims.

1-12. (canceled)

13. A method of analyzing and visualizing a network, said network including nodes interconnected by links,
characterized in
said method includes steps of:
mapping a topology of the network;
creating an adjacency representation A of said network;
calculating an Eigenvector Centrality (EVC) score for each node;
identifying a set of neighbouring nodes from said adjacency representation A for each node in the network;
from said set of neighbouring nodes and EVC score, identifying for each node a neighbouring node thereto, wherein said neighbouring node has a highest calculated EVC score; and
creating a representation Ã with entries for each link in the network, in which the entry for a given link is set to indicate if it is a link between a node and its neighbour with the highest EVC score, said representation Ã being a Steepest Ascent Graph (SAG) of the network.

14. A method as claimed in claim 13, wherein said representations A and Ã are implemented as matrices.

15. A method as claimed in claim 12, said method including additional steps of:
(a) multiplying a start vector sᵢ=i, i being a node number, with a Steepest Ascent Graph of the network expressed as a matrix Ã;
(b) iterating step (a) until the start vector s converges to a stable vector s*; and
(c) reading off a regional membership of each node from said stable vector s*.

16. A method as claimed in claim 15, said method including additional steps of:
identifying nodes which are local maxima of the Steepest Ascent Graph (SAG) as center nodes;
grouping the nodes into regions surrounding each identified center node;
removing said center nodes and the links to said center nodes from the Steepest Ascent Graph (SAG);
identifying neighbouring nodes of said center nodes as subregion head nodes; and
grouping nodes into subregions surrounding each identified subregion head node, the nodes of a subregion being linked, via one or more hops, to the subregion head node in the Steepest Ascent Graph (SAG).

17. A method as claimed in claim 16, said method including additional steps of:
identifying neighbouring nodes of said head nodes as sub-subregion head nodes; and
grouping nodes into sub-subregions surrounding each identified sub-subregion head node, the nodes of a sub-subregion being linked to the sub-subregion head node in the Steepest Ascent Graph (SAG).

18. A method as claimed in claim 16, said method including additional steps of:
identifying regions of said network;
calculating a Steepest Ascent Graph (SAG) for each region separately; and
displaying one or more of the Steepest Ascent Graphs (SAG) on a display unit using force-balancing.

19. A method as claimed in claim 16, said method including additional steps of:
identifying regions and center nodes in said network;
calculating a Steepest Ascent Graph for each region separately;
identifying subregions in said network;
determining the size of each subregion;
selecting a threshold size T;
removing subregions smaller than said threshold size T from the graphs;
for each graph calculating the net link strength between each pair of subregions;
removing the center node from each region;
building a coarse-grained graph in which each subregion is represented as a single node using inter-subregion net link strengths as links; and
displaying the coarse-grained graphs for each region on the display unit using force-balancing.

20. A device for analyzing and visualizing a network, said network including nodes interconnected by links,
characterized in that
the device includes a controller and data storage for a database, the database being adapted to receive setup information for said nodes, the controller being operable:
to map a topology of the network from said setup information;
to create an adjacency representation A of said network;
to identify a set of neighbouring nodes from said adjacency representation A for each node in the network;
to calculate an Eigenvector Centrality (EVC) score for each node;
from said set of neighbouring nodes and EVC scores, to identify for each node a neighbouring node thereto, said neighbouring node having a highest calculated EVC score; and
to create a representation Ã with entries for links in the network, in which an entry for a given link is set to indicate it is a link between a node and its neighbour with the highest EVC score, said representation Ã being a Steepest Ascent Graph (SAG) of the network.

21. A device as claimed in claim 20, wherein the device includes an interface for interfacing to said network, the device being adapted to retrieve setup information from said nodes.

22. A device as claimed in claim 21, wherein the device is operable to retrieve traffic data from said nodes.

23. A computer readable medium bearing computer code which, when executed by a processor controls the processor to carry out the steps described in claim 13.
